(19) United States
(12) Patent Application Publication
(10) Pub. No.: US 2025/0279252 A1
(43) Pub. Date: Sep. 4, 2025

(54) MOTORIZED HIGH VOLTAGE IN-LINE DISCONNECT SWITCH WITH CORONA PREVENTING INTERNAL COOLING FINS

(71) Applicant: CLEAVELAND/PRICE INC., TRAFFORD, PA (US)

(72) Inventor: CHARLES M. CLEAVELAND, GREENSBURG, PA (US)

(73) Assignee: CLEAVELAND/PRICE INC., TRAFFORD, PA (US)

(21) Appl. No.: 18/982,191

(22) Filed: Dec. 16, 2024

Related U.S. Application Data
(60) Provisional application No. 63/560,891, filed on Mar. 4, 2024.

(51) Int. Cl. H01H 31/28; H01H 3/26; H01H 9/52

(52) U.S. Cl. CPC H01H 31/28; H01H 3/26; H01H 9/52; H01H 2031/286; H01H 2239/044

(57) ABSTRACT

A high voltage motorized in-line air break disconnect switch having a rotating switch blade with two parallel elongated rectangular metal conductors having rounded top and bottom edges include a gap between the conductors. Heat conducting cooling fin units are attached to an inner side of at least one of the conductors and are positioned entirely within the gap. No part of each cooling fin unit extends above the rounded top edge or below the rounded bottom edge of a conductor to which it is attached. Corona electrical stress between the heat conducting cooling fins and a ground plane is prevented. The two conductors act as electric shields to prevent corona even with the inclusion of the cooling fin units positioned within the gap between the two conductors, permitting a reduction in the size and weight of the conductors compared to conductors without the cooling fin units.

### CROSS-REFERENCE TO RELATED APPLICATION

This application claims the benefit of U.S. Provisional Application No. 63/560,891 filed Mar. 4, 2024, which is incorporated herein by reference in its entirety as though fully set forth.

### BACKGROUND OF THE INVENTION

The present invention relates generally to an air break disconnect switch for high voltage electrical applications and, more particularly, to a motorized in-line high voltage air break disconnect switch that mounts in-line with a transmission line conductor without the need of a group operated switch with associated ground supported mounting structure. Such a motorized in-line high voltage disconnect switch hangs from and is supported by its associated transmission line.

Such a motorized in-line high voltage air break disconnect switch may include a hinge mounted at one end of a rotating switch blade. The rotating switch blade includes two parallel current carrying copper conductors, each of equal dimensions. The two parallel current carrying copper conductors being attached to and separated from one another by one or more spacer elements.

A motorized in-line high voltage air break disconnect switch can be used to sectionalize long transmission lines, disconnect lines from substations, serve as a line tap switch, and serve as a temporary maintenance switch, for example. It allows for easy, cost-efficient sectionalizing of high voltage transmission lines and isolation in high voltage substations.

One example of such a motorized in-line high voltage air break disconnect switch including a hinge mounted rotating switch blade is disclosed in U.S. Pat. No. 9,881,755 B1 by Charles M. Cleaveland issued on Jan. 30, 2018, to Cleaveland/Price Inc., the present assignee, entitled “Motorized High Voltage In-Line Disconnect Switch With Hand-Held Communication System to Prevent Unwanted Operation”. This switch includes an elongated strain insulator supporting an elongated rotating switch blade having a hinge end and a break jaw contact end. The rotating switch blade is rotatable about a hinge pin at the hinge end during opening and closing of the switch. The switch includes a motor connected to an output shaft to cause the hinge end of the switch blade to rotate when energized to open or close the switch. A communication system actuates the motor to cause the switch to open and close as desired. This Cleaveland/Price Inc. patent discloses embodiments of an in-line motorized high voltage disconnect switch. The in-line motorized high voltage disconnect switch includes an elongated switch blade that is rotatable at one end of the switch blade, i.e., about the hinge end.

Another example of such a motorized in-line high voltage air break disconnect switch including a hinge mounted rotating switch blade is disclosed in U.S. Pat. No. 9,966,207 B1 by Charles M. Cleaveland issued May 8, 2018, to Cleaveland/Price Inc., the present assignee, entitled “Motorized High Voltage In-Line Disconnect Switch with Communication System Controls”. This switch includes a rotating switch blade that is operated by a communication system controlled motor that may include a switch mounted communication device, such as a radio which is controlled by another such communication device located at ground level. The switch is battery operated and solar charged. This Cleaveland/Price Inc. patent also discloses embodiments of an in-line motorized high voltage disconnect switch. The in-line motorized high voltage disconnect switch includes an elongated switch blade that is rotatable at one end of the switch blade, i.e., about the hinge end.

The said U.S. Pat. No. 9,881,755 B1 and said U.S. Pat. No. 9,966,207 B1 are both incorporated herein by reference in their entireties as though fully set forth.

The electric utility industry needs higher current ratings for transmission lines. This higher current rating for motorized in-line high voltage air break disconnect switches results in the need for larger copper conductors such that the weight of the switch blade is too heavy for the motor of the switch to reliably open and close. Also, the cost of copper has increased significantly in recent years, so it is desirable to reduce the amount of copper required for the switch. Furthermore, as can be seen by the above referenced patent publications, it is often a feature of such motorized in-line high voltage air break disconnect switches to incorporate a manual hook operation in case the motor or associated communication system for operating the motor is inoperative. In such a case a heavy switch blade can be very difficult to manually operate.

It is therefore the object of this invention to provide an improved motorized in-line high voltage air break disconnect switch for high current transmission lines having a switch blade with parallel copper conductors with reduced weight compared to existing such switch blades with the same current rating without causing corona stress to the switch.

### SUMMARY OF THE INVENTION

The object of the invention is achieved by the motorized in-line high voltage air break disconnect switch of the present invention having an improved switch blade for high current transmission line applications. A high voltage motorized in-line air break disconnect switch is provided having a rotating switch blade with two parallel elongated oppositely disposed rectangular metal electrical conductors having rounded top and bottom edges which include an air gap between the conductors. Heat conducting cooling fin units are attached to an inner side of at least one of the conductors and are positioned entirely within the air gap. Each cooling fin unit includes a plurality of parallel oppositely disposed heat conducting cooling fins. No part of each cooling fin unit extends above the rounded top edge or below the rounded bottom edge of a conductor to which it is attached. Corona electrical stress between the heat conducting cooling fins and a ground plane when the switch is in a horizontal closed conductive switch position is prevented. The two conductors act as electric shields to prevent corona even with the inclusion of the cooling fin units positioned within the gap between the two conductors, permitting a reduction in the size and weight of the conductors compared to conductors without the cooling fin units.

The motorized in-line high voltage air break disconnect switch 10 shown in FIGS. 1, 2, and 3 has a switch blade 20 having two switch blade elongated current carrying copper conductors 1, 2 which are solid copper and have a rectangular cross-section and equal dimensions. The length of the two copper conductors 1, 2 is according to the voltage rating of the switch. The two current carrying copper conductors 1, 2 have a combined rating of 1200 A. (amperes). The electric industry commonly needs higher current rating for transmission lines, as mentioned. FIG. 4 shows larger switch blade copper conductors 3, 4, i.e., having a greater height dimension than the smaller current carrying copper conductors 1, 2 shown in FIGS. 1-3, for the same conductor thickness. The larger switch blade copper conductors 3, 4 have for example a combined 2000 A. rating and are ¼ inch thick×3 inches high as compared to the smaller current carrying copper conductors 1, 2; which are ¼ inch thick×1½ inches high with a combined 1200 A. size shown in FIGS. 1, 2, and 3. The length of the two smaller copper conductors 1, 2 or the two larger copper conductors 3, 4 is according to the voltage rating of the switch. Now for the industry rating of a combined 3000 A., the copper conductors would have to be ¼ inch thick×6 inches high to meet the required 53° C. (centigrade) temperature standard limitation of IEEE standard C 37.30.1. At high voltage the length of one of the switch blade copper conductors at 230 kV, for example, would be about 93 inches and the weight of ¼ inch thick×6 inches high×93 inches long copper conductor is so heavy that the motor of the motorized switch cannot reliably open and close the switch. Nor can the motorized switch be manually operated due to the weight.

This combined 3000 A. rating for such a motorized in-line high voltage air break disconnect switch using only ¼ inch thick×3 inch high solid copper conductors is possible with the present invention's novel addition of aluminum cooling fins operatively disposed in the air gap between the two copper conductors. The two copper conductors 3, 4, as mentioned, have full rounded top and bottom edges that prevent electric corona. It is noted that at high voltage above 69 kV, that the sharp edges of typical cooling fins would cause a corona problem, and, therefore, the addition of such fins to the switch blade conductors of such a very high voltage has not been considered possible in the U.S. electric utility industry. However, the present invention teaches the addition of the cooling fins is possible for such a switch, if the fins are placed entirely within the air gap between the two switch blade conductors 3, 4, having full rounded top and bottom edges which shields the fins from the corona problem, because the sharp edges of the fins are positioned internal of the electric field surrounding the switch blades which prevents corona.

The present invention utilizes a motorized in-line high voltage air break disconnect switch such as disclosed in the present assignee's said U.S. Pat. No. 9,881,755 B1 and said U.S. Pat. No. 9,966,207 B1, for example, but the elongated rotatable switch blade has been improved for high current applications by including at least one heat conducting cooling fin unit. Each heat conducting cooling fin unit includes a plurality of parallel equally spaced cooling fins. Each heat conducting cooling fin unit is specifically positioned entirely within the air gap between the two elongated switch blade metal conductors.

As shown in FIG. 5 each of the two switch blade parallel current carrying solid copper conductors have the same dimensions, including length, height, and thickness as the combined 2000 A. rated blades shown in FIG. 4, for the same switch voltage rating. The cooling fins of each cooling fin unit are operatively positioned entirely within the air gap between the conductors with no part of the fins or other part of the cooling fin unit extending above the rounded top edge of each conductor or below the rounded bottom edge of each conductor.

Preferably, the motorized in-line high voltage vertical air break disconnect switch includes a plurality of the cooling fin units. Preferably, each cooling fin unit is made from extruded aluminum and comprises a plurality of operatively arranged equally spaced parallel fins attached to a cooling fin unit base and having heat convecting elongated channels formed between each pair of equally spaced oppositely disposed cooling fins and the cooling fin unit base. Each heat conducting cooling fin is desirably rectangular and of the same dimensions as the other cooling fins. The heat convecting elongated channels each have a U-shaped cross-section when viewed from above the cooling fin unit, for example. The elongated channels are oriented perpendicular to the length and parallel to the height of the associated attached elongated copper conductor in the operative position. This orientation of the elongated channels is necessary for maximum cooling air flow when the switch blade is in the horizontal closed conductive switch position. Each cooling fin unit is operatively attached to the inner side of one of the copper conductors in perpendicular orientation with respect to the length of the attached copper conductor.

Preferably, each cooling fin unit has a height dimension that is a predetermined amount less than the height dimension of each of the parallel copper conductors. Preferably, the cooling fin units in the operative position are attached to the inner side of the respective copper conductor in heat transfer relationship therewith. Also, preferably each of the two parallel current carrying copper conductors have full rounded top and bottom edges to prevent corona.

These and other aspects of the present invention will be further understood from the detailed description of the invention, drawings, and claims.

### BRIEF DESCRIPTION OF THE DRAWINGS

For a better understanding of the invention reference may be made to the accompanying drawings exemplary of the invention, in which:

FIG. 1 shows a perspective view of the present assignee's motorized in-line air break switch in the horizontal closed conductive switch position as shown in the said U.S. Pat. No. 9,881,755 B1 and said U.S. Pat. No. 9,966,207 B1, showing the elongated rotatable switch blade current carrying conductors labeled as numerals 1 and 2 having a 1,200 amp combined rating, for example;

FIG. 2 shows a perspective view of the same switch as shown in FIG. 1 with housing 11 removed to show the motor, and showing current carrying conductors labeled as numerals 1 and 2;

FIG. 3 shows a side view of the motor 12 and gear mechanism 48 within housing 11 with one side of the housing removed, the switch blade is labeled as numeral 20;

FIG. 4 shows the same switch as FIG. 1 (having 1,200 A. conductors), but with higher current carrying conductors, i.e., larger combined 2000 A. conductors, labeled as numerals 3 and 4;

FIG. 5 shows the switch of the present invention using the same switch as FIG. 4, but with the addition of cooling fin units 8, 9 that increase the combined current rating of both conductors to 3000 A., while the current carrying conductors 3 and 4 maintain the same dimensions as the conductors 3, 4 shown in FIG. 4 for the combined 2000 A. conductors, for the same switch voltage; and,

FIG. 5A is an enlarged section view of the switch taken along the line ‘A’-‘A’ of FIG. 5 cutting through the elongated polymer strain insulator 22 and the conductors 3 and 4, also shown are cooling fin units 8, 9 with cooling fins labeled as numerals 5 and 6.

### DETAILED DESCRIPTION OF THE INVENTION

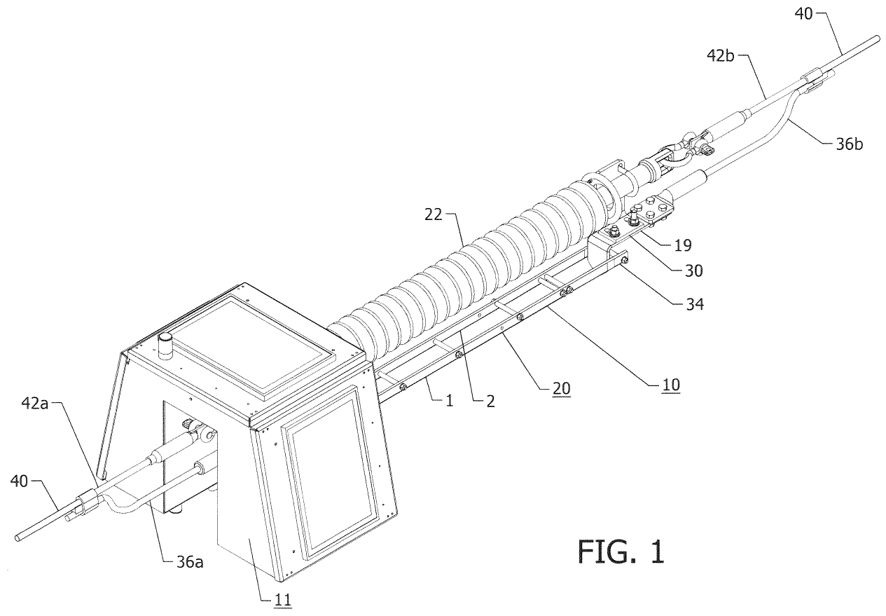

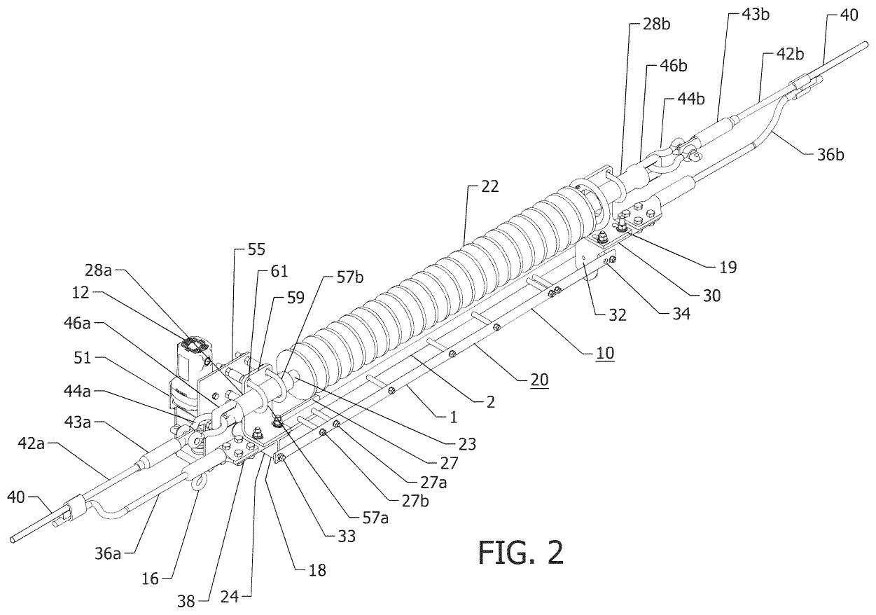

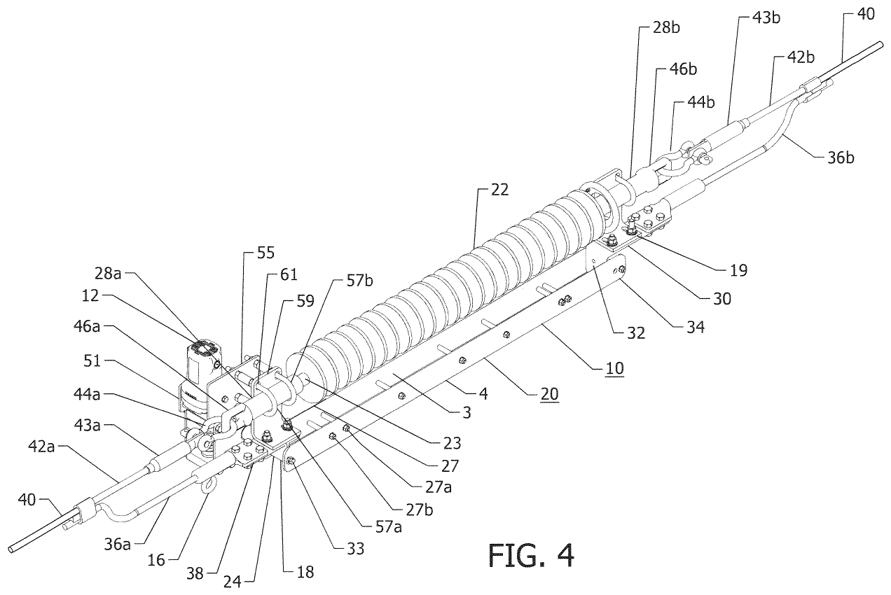

The present assignee's motorized in-line high voltage air break disconnect switch 10 of the said U.S. Pat. No. 9,881,755 B1 and said U.S. Pat. No. 9,966,207 B1, is shown in FIGS. 1, 2, 3, and 4 in the horizontal closed conductive switch position. Common switch current carrying parts for rotating switch blade 20 are shown in FIGS. 1-4. As already mentioned, the switch blade 20 can include two parallel elongated larger current carrying metal conductors 3, 4, as shown in FIG. 4, which are preferably solid copper. The current carrying conductors 3, 4 are solid elongated rectangular conductors. As seen in FIG. 2 a hinge contact member 24 is included at the hinge end 18 of the switch 10 and is connected in circuit to a hinge terminal 38. The hinge contact member 24 includes a hinge pin 33 that switch blade 20 rotates about. The switch blade 20 initially opens downwardly from the horizontal closed switch position shown in FIGS. 1, 2, 3, and 4, by rotating about hinge pin 33 until it is perpendicular relative to the strain insulator 22, then the switch blade 20 is caused to continue to rotate, now upwardly, until it reaches a horizontal full open position, 180 degrees from its closed conductive position, the horizontal full open position is not shown in the drawings, but is shown in the respective FIG. 2 of each the previously mentioned Cleaveland Price, Inc. patents, i.e., said U.S. Pat. No. 9,881,755 B1 and said U.S. Pat. No. 9,966,207 B1. The hinge end 18 of the switch 10 is mounted proximate one end 28a of the strain insulator 22. The strain insulator 22 has a fiberglass rod 23 for supporting the insulator 22 which passes through the center of the insulator 22. The switch 10 also includes a break jaw end 19 which is mounted proximate the other end 28b of the strain insulator 22 and a switch break jaw contact terminal 30. The switch break jaw contact terminal 30 includes an integral break jaw contact 32 for contacting the switch blade end 34 when the switch is in the electrically closed position. The switch 10 also typically includes jumpers 36a, 36b attached in circuit respectively, to the hinge terminal 38 and the switch break jaw terminal 30. As shown in FIG. 2, a high voltage transmission line 40 has been cut, resulting in two transmission line ends 42a, 42b. Each transmission line end 42a, 42b is respectively attached to strain cable fittings 43a, 43b and to shackles 44a, 44b. The shackles 44a, 44b respectively engage chain eye end fittings 46a, 46b at the ends 28a, 28b of the strain insulator 22. The transmission line 40 may support the in-line air break disconnect switch 10 without the switch 10 being attached directly to a dedicated ground support structure, such as metal framework. The jumpers 36a, 36b carry the transmission line current in circuit with the switch blade 20 via the switch break jaw contact terminal 30 and the hinge terminal 38.

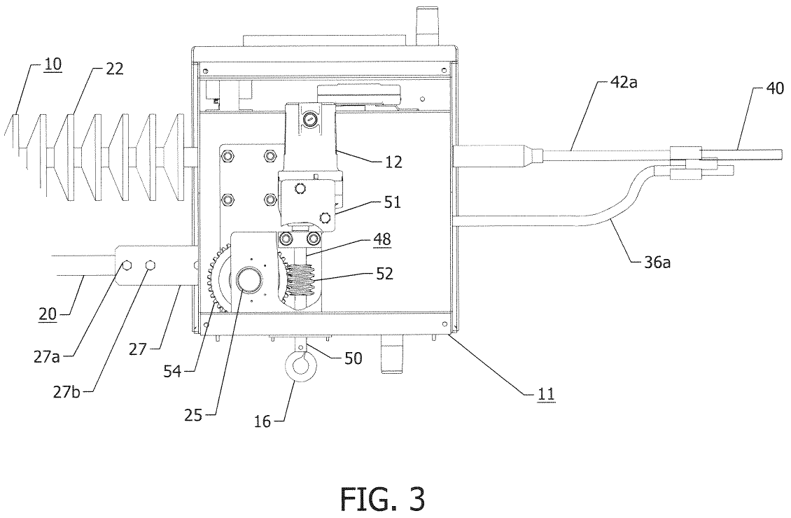

The present assignee's motorized in-line air break disconnect switch 10 in addition to these common current carrying parts includes the following. A housing 11 for housing the motor 12 and protecting the hinge end 18 of switch 10 from icing is shown in FIG. 1. The motor 12 is included for driving a worm drive 48, which is shown in FIG. 3. The worm drive 48 includes shaft 50 of the motor 12 operatively attached to a worm 52 carried by the worm shaft 50, which is in operative engagement with a worm gear 54 carried on the output shaft 25. The output shaft 25 is connected to drive bar 27 which is connected at bolts 27a, 27b to the switch blade 20 for rotational motion. The motor 12 is carried on a motor mounting 51 as shown in FIG. 2. The motor mounting 51 is attached to plate 55 which carries U-bolts 57a, 57b as shown in FIGS. 2, 4 and 5. The motor 12 may be a type AC/DC having a ¾ horsepower rating, for example. The U-bolts 57a, 57b pass through apertures 61 in L-shaped bracket 59, shown in FIGS. 2, 4 and 5. The one end 28a of the strain insulator 22 passes through the U-bolts 57a, 57b as shown in FIG. 2. FIG. 2 and FIG. 3 show a manual operating eye ring 16 is attached at the end of the worm shaft 50 for cooperating with a hookstick for manual rotational operation, not shown, in case the motor 12 is inoperable. An energy supply for powering the electric motor 12, such as a battery, is also enclosed within the housing 11, but is not shown in the drawings.

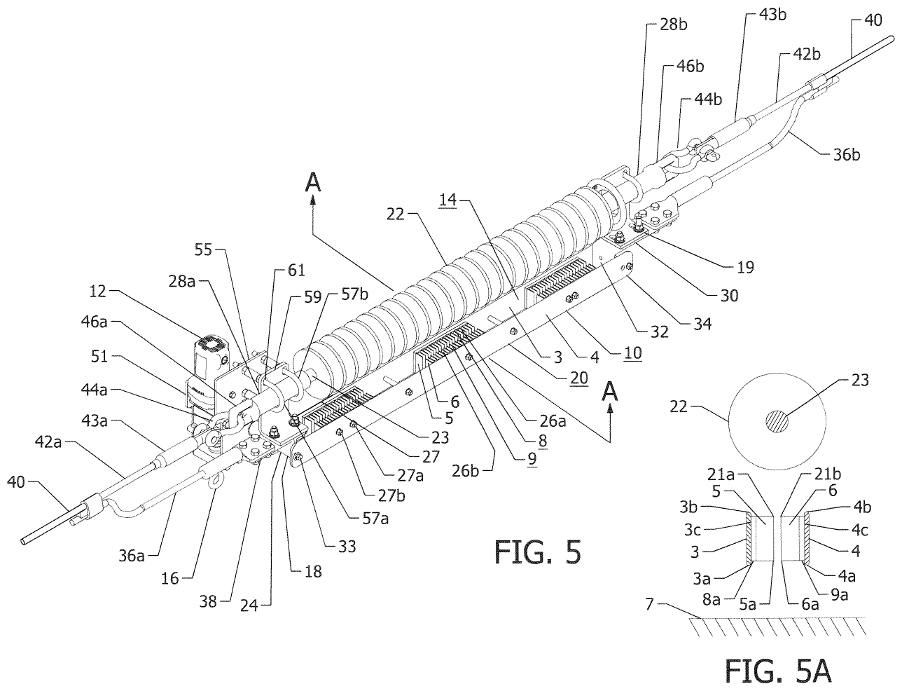

The two larger current carrying conductors 3, 4 are preferably solid elongated copper conductors having respectively a substantially rectangular cross-section, as shown in FIG. 5A. The conductors 3, 4 each have, respectively, a rounded bottom edge 3a, 4a, and a rounded top edge 3b, 4b.

As shown in FIGS. 5 and 5A, conductor 3 has attached to an inner side 3c thereof, within an air gap 14 between the conductors 3, 4, at least one heat conducting sharp-edged parallel fin cooling unit 8. The air gap 14 is elongated and limited to the three dimensional space between the two parallel elongated oppositely disposed conductors 3 and 4 as shown in FIG. 5, which is limited to the space between the rounded bottom edges 3a, 4a and the rounded top edges 3b, 4b of the respective conductors 3, 4.

Each heat conducting sharp-edged parallel fin cooling unit 8 includes an integral cooling fin base 8a having a plurality of integral parallel equally spaced and dimensioned adjoining fins 5 protruding perpendicularly from the base 8a, as shown in FIGS. 5 and 5A. The cooling fin unit 8 is preferably made of extruded aluminum. Each cooling fin unit 8 is attached to the conductor 3 such that the fins 5 are perpendicular to the conductor 3 extending transversely in the direction of the opposite conductor 4. Between each pair of adjoining fins 5 is a heat convecting elongated channel 26a. Each heat convecting elongated channel 26a may have a U-shaped cross-section. Each heat convecting elongated channel 26a is oriented perpendicular to the length and parallel to the height of the conductor 3. Each cooling fin unit 8 may have twenty six (26) heat conducting fins 5, for example. The cooling fin unit 8 may be attached to the conductor 3 by bolts, for example. Such a cooling fin unit 8 is readily commercially available.

Conductor 4 has attached to an inner side 4c thereof, within the air gap 14 between the conductors 3, 4, at least one heat conducting sharp-edged parallel fin cooling unit 9, similar to the at least one heat conducting sharp-edged parallel fin cooling unit 8 as described above.

Each heat conducting sharp-edged parallel fin cooling unit 9 includes an integral cooling fin base 9a having a plurality of integral parallel equally spaced and dimensioned adjoining fins 6 protruding perpendicularly from the base 9a, as shown in FIGS. 5 and 5A. The cooling fin unit 9 is also preferably made of extruded aluminum. Each cooling fin unit 9 is attached to the conductor 4 such that the fins 6 are perpendicular to the conductor 4 extending transversely in the direction of the opposite conductor 3, as shown in FIGS. 5 and 5A. Between each pair of adjoining fins 6 is a heat convecting elongated channel 26b. Each heat convecting elongated channel 26b is oriented perpendicular to the length and parallel to the height of the conductor 4. Each heat convecting elongated channel 26b may have a U-shaped cross-section. Each cooling fin unit 9 may have twenty six (26) heat conducting fins 6, for example. The cooling fin unit 9 may be attached to the conductor 3 by bolts, for example. The cooling fin unit 9, maybe the same as the cooling unit 8, and is therefore also readily commercially available.

The fins 5 and 6 are sharp edged because of the manufacturing process of making the extruded aluminum fins. Which process includes each of the heat conducting sharp-edged cooling fin units 8, 9 are formed by cut off of extruded bar material.

With reference to FIGS. 5 and 5A, the cooling fin units 8, 9 in the operative position are attached to the inner side 3c, 4c of the respective copper conductor 3, 4 within the air gap 14 such that the top of each cooling fin unit 8, 9 is preferably below the top edge of the attached respective conductor 3, 4, and the bottom of each cooling fin unit 8, 9 is preferably above the bottom edge of the attached respective conductor 3, 4, which allows the sharp edges of the respective fins 5, 6 to be shielded by the respective full round edges 3a, 3b, 4a, 4b of the conductors 3, 4 from corona.

Attention is called to the typical bottom sharp corner edges of the extruded aluminum fins labeled as 5a and 6a and the typical top sharp corner edges of the extruded aluminum fins labeled as 21a and 21b, as shown in FIG. 5A. Note that the conductors 3 and 4 have full round bottom edges labeled as 3a and 4a and full round top edges 3b and 4b which do not cause corona because they are not sharp.

The bottom cooling fin sharp corner edges 5a, 6a do not cause corona because the fins are nested within the air gap 14 between the copper conductors 3 and 4. The pair of conductors 3, 4 act as a shield to the bottom cooling fin sharp corner edges Sa, 6a that are between the conductors 3, 4 as seen from a ground plane 7 below the switch, when the switch blade 20 is in the horizontal closed conductive position, as shown in FIGS. 5 and 5A. The fins 5, 6 are internal to the switch 10 and are not directly exposed to the ground plane 7. Top cooling fin sharp corner edges 21a and 21b could also cause corona because they also cause stress relative to the ground plane 7, but do not cause corona because they are shielded by the round top edges 3b, 4b of the conductors 3, 4.

Electric corona is caused when the voltage of the switch is increased above 69 kV to the point when air becomes conductive and is no longer an insulating media between the surface of the switch and a ground plane. This can be observed at night as a glowing of light emitting from surfaces of the switch where there are sharp points that cause electric stress to the air. Computer electric field plots can show the onset of corona dependent on how sharp the surface is at a given voltage between the switch and the ground plane. These computer electric field plots, that show in color, high corona stress points have been run at the facility of the present assignee, Cleaveland/Price Inc. These plots show that the two conductors 3, 4 with full round edges do in fact, shield the sharp edges of the fins within the gap 14 so that the sharp edges have the same corona stress level as the acceptable level of the full round edges of the conductors.

If the fins 5, 6 were attached outside of each conductor, beyond the gap 14, the electric stress on the sharp edges of the extruded aluminum fins would cause a glowing at night and cause unwanted radio noise interferences no longer permitted by IEEE standards today.

The addition of multiple cooling fin units such as 8, 9 with respective fins 5, 6 shown in FIGS. 5 and 5A would allow a combined 3000 A. rating, as already mentioned, for the present assignee's Cleaveland/Price Inc. motorized in-line air break disconnect switch shown in FIG. 4; which switch is sold in the U.S. under the assignee's, Cleaveland/Price Inc., U.S. registered trademark AutoLine®. The improved motorized in-line disconnect switch with the cooling fin units of the present invention will have great commercial value in the electric switch industry and specifically has never been done to motorized in-line switches.

### LIST OF REFERENCE NUMERALS

1 smaller current carrying conductor
2 smaller current carrying conductor
3 larger current carrying conductor, solid elongated rectangular metal conductor
3a rounded bottom edge of 3
3b rounded top edge of 3
3c inner side of 3
4 larger current carrying conductor, solid elongated rectangular metal conductor
4a rounded bottom edge of 4
4b rounded top edge of 4
4c inner side of 4
5 sharp-edged cooling fin
5a cooling fin sharp corner edge bottom of 5
6 sharp-edged cooling fin
6a cooling fin sharp corner edge bottom of 6
7 ground plane
8 heat conducting sharp-edged cooling fin unit
8a cooling fin unit base
9 heat conducting sharp-edged cooling fin unit
9a cooling fin unit base
10 motorized in-line air break disconnect switch
11 housing
12 motor
14 air gap between 3 and 4
16 manual operating eye ring
18 hinge end of 10
19 break jaw end of 10
20 elongated rotatable switch blade
21a cooling fin sharp corner edge top of 5
21b cooling fin sharp corner edge top of 6
22 polymer strain insulator
23 fiberglass rod
24 hinge contact member
25 motor output shaft
26a heat convecting elongated channels of 8
26b heat convecting elongated channels of 9
27 drive bar
27a drive bar bolt
27b drive bar bolt
28a one end of strain insulator
28b other end of strain insulator
30 switch break jaw contact terminal
32 integral break jaw contact
33 hinge pin
34 switch blade end
36a jumper
36b jumper
38 hinge terminal
40 transmission line
42a transmission line end
42b transmission line end
43a strain cable fitting
43b strain cable fitting
44a shackle
44b shackle
46a chain eye end fitting
46b chain eye end fitting
48 worm drive
50 worm shaft
51 motor mounting
52 worm
54 worm gear
55 plate
57a U-bolt
57b U-bolt
59 L-shaped bracket
61 apertures in 59

Of course variations from the foregoing embodiments are possible without departing from the scope of the invention.

What is claimed is:

1. A high voltage motorized in-line air break disconnect switch operatively supported and suspended by and mounted in-line with an electric power line conductor, the high voltage motorized in-line air break disconnect switch having an open non-conductive position and a closed conductive position, the high voltage motorized in-line air break disconnect switch comprising:
an elongated strain insulator operatively supported and suspended by the electric power line conductor,
an elongated rotating switch blade extending in parallel spaced relationship with and supported by the elongated strain insulator at each end thereof,
the elongated rotating switch blade including a hinge end and a break jaw contact end,
the rotating switch blade including two parallel elongated rectangular metal conductors having an air gap therebetween,
the two parallel elongated rectangular metal conductors each having a substantially rectangular cross-section,
the two parallel elongated rectangular conductors having a rounded top edge and a rounded bottom edge,
a hinge contact member in operative electric circuit arrangement with the elongated rotating switch blade at the hinge end thereof,
the hinge contact member in operative supportive relationship with a hinge pin, the hinge pin in rotatable supportive relationship with the elongated switch blade at the hinge end,
a hinge contact terminal including an integral hinge and a break jaw contact terminal including an integral break jaw operatively supported by the elongated strain insulator at one end thereof, the break jaw contact end of the elongated switch blade in operative electric circuit arrangement with the break jaw contact terminal when the high voltage motorized in-line air break disconnect switch is in the closed conductive position,
a first electrical connection in operative electric circuit arrangement between the electric power line conductor and the hinge contact terminal and a second electrical connection in operative electric circuit arrangement between the electric power line conductor and the break jaw contact terminal,
a motor in operative arrangement with an output shaft for causing the hinge end of the elongated rotating switch blade to rotate upon the motor actuation into operative electric closed circuit arrangement with the break jaw contact in the closed conductive switch position and to rotate upon motor actuation out of operative electric closed circuit arrangement with the break jaw contact into the open non-conductive switch position,
an energy supply for powering the motor,
at least one of the two parallel elongated rectangular metal conductors having operatively affixed to an inner side thereof, within the air gap, at least one heat conducting cooling fin unit,
the at least one heat conducting cooling fin unit including a plurality of heat conducting parallel cooling fins extending perpendicular to the elongated rectangular metal conductors,
the at least one heat conducting cooling fin unit positioned entirely within the air gap,
the at least one heat conducting cooling fin unit including the plurality of the heat conducting parallel cooling fins positioned to not extend above the rounded top edges and to not extend below the rounded bottom edges of the two parallel elongated rectangular metal conductors,
wherein the size and weight of the two parallel elongated rectangular metal conductors is reduced as a result of the increased current carrying capacity of the two parallel elongated rectangular metal conductors due to the heat conducting parallel cooling fins, and,
wherein corona electrical stress between the heat conducting cooling fins and a ground plane is prevented by the positioning of the heat conducting cooling fin units including the heat conducting cooling fins entirely within the air gap between the two parallel elongated rectangular metal conductors, which act as electric shields to prevent unwanted corona.

2. The high voltage motorized in-line air break disconnect switch of claim 1, wherein each of the heat conducting cooling fin units comprises an integral cooling fin base having the plurality of the heat conducting parallel cooling fins protruding perpendicularly from the base and spaced from one another and having sharp edges around the perimeter of the respective cooling fin.

3. The high voltage motorized in-line air break disconnect switch of claim 1, wherein the two parallel elongated rectangular metal conductors are solid metal conductors.

4. The high voltage motorized in-line air break disconnect switch of claim 1, wherein each of the two parallel elongated rectangular metal conductors are made of copper or aluminum.

5. The high voltage motorized in-line air break disconnect switch of claim 2, wherein each heat conducting cooling fin unit comprises a predetermined number of the plurality of the heat conducting parallel cooling fins.

6. The high voltage motorized in-line air break disconnect switch of claim 1, wherein each of the heat conducting cooling fin units are positioned entirely within the air gap between the two parallel elongated rectangular metal conductors with no part of the heat conducting sharp-edged cooling fin unit extending beyond the air gap.

7. The high voltage motorized in-line air break disconnect switch of claim 2, wherein each of the heat conducting cooling fin units are made of extruded aluminum.

8. The high voltage motorized in-line air break disconnect switch of claim 2, wherein the heat conducting sharped-edged parallel cooling fins are configured to be formed by cut off of extruded bar material.

9. The high voltage motorized in-line air break disconnect switch of claim 2, wherein each of the heat conducting cooling fin units have a heat convecting elongated channel between each pair of adjoining heat conducting parallel cooling fins.

10. The high voltage motorized in-line air break disconnect switch of claim 9, wherein each of the heat convecting elongated channels is oriented perpendicular to the length and parallel with the height of the rectangular elongated metal conductor to which the heat conducting cooling fin unit is attached.

11. The high voltage motorized in-line air break disconnect switch of claim 10, wherein each of the heat convecting elongated channels has a U-shaped cross-section.

12. The high voltage motorized in-line air break disconnect switch of claim 5, wherein each of the heat conducting cooling fin units has a height dimension that is equal to, or, preferably less than the height dimension of each of the two parallel elongated rectangular metal conductors, wherein corona from the sharp edges of the heat conducting parallel cooling fins is prevented.

13. The high voltage motorized in-line air break disconnect switch of claim 10, wherein each of the heat convecting elongated channels is oriented substantially perpendicular with respect to the ground plane in the electrically closed switch position.
